(19) United States
(12) Patent Application Publication
(10) Pub. No.: US 2016/0217004 A1
(43) Pub. Date: Jul. 28, 2016

(54) CONTROL METHOD FOR A PORTABLE ELECTRONIC DEVICE COMING WITH AN EXTERNAL CONTROL MODULE

(71) Applicant: Nextdrive Inc., Grand Cayman (KY)

(72) Inventors: Shu-Yu LIN, New Taipei City (TW); Che-Yuan YEN, New Taipei City (TW); Chung-Kuang CHEN, New Taipei City (TW)

(21) Appl. No.: 14/606,584

(22) Filed: Jan. 27, 2015

(51) Int. Cl. G06F 9/48; G06F 21/60

(52) U.S. Cl. CPC G06F 9/4843; G06F 21/604; G06F 9/48

(57) ABSTRACT

The disclosure is related to a control method for a portable electronic device coming with an external control module. A main body of the control module has a built-in circuit system and a power supplying unit. The circuit system has a processor, and the power supplying unit provides power to the circuit system and the processor required. Then, the processor is electronically connected with an electronic connector. The processor may acquire a controlling authority for the operating system (iOS or Android) of the default portable electronic device by electronically connecting the electronic connector to the default portable electronic device outside (which may be a smart-phone, a tablet or a notebook), to achieve the purpose for providing electronic signals transmission and storing between the control module and the default portable electronic device, and to reduce the operating steps and procedures when the default portable electronic device transmits the electronic signals.

### BACKGROUND OF THE INVENTION

1. Field of the Invention

The present disclosure relates to a control method for a portable electronic device coming with an external control module, and more particularly to the control module which can acquire a control authority for the operating system of the portable electronic device. The control module has a built-in processor electronically connected with an electronic connector and the electronic connector is electronically connected with the default portable electronic device, such that the control authority for the operating system may be acquired by the processor, and the purpose of transmitting and storing electronic signals can be achieved.

2. Description of the Related Art

With the continuous advance of electronic technology, it also leads to an improvement of communication apparatus. In the modern society with high development of the Internet, in addition to a landline, a cell-phone or a smart-phone, an instant communication with the constraints of countryless, timeless or regionless may be achieved by portable electronic devices, such as a smart-phone, a tablet or a notebook. In addition, it may also use a video instant chat and a video communication to let people become closer via the Internet communication, so that the communication between persons becomes more convenient. Furthermore, based on the convenience of the Internet, lots of network platform companies and software developers create various software programs, applications, operating system programs, communication interfaces, game software or on-line games, and after users download related operating programs and applications, the users can perform more operating applications and games, and it results in the popularization of the smart-phone, the tablet or others electronic devices in recent years. Whether workers or students, even seniors or youths, etc., they may use the smart-phone, the tablet or the others electronic devices to perform the operation for the various applications or the games by connecting to the Internet or employing the wireless communication. However, when using the smart-phone, the tablet, or the others electronic devices to download various applications and operating programs from the Internet, a built-in operating system of the smart-phone, the tablet, or the others electronic devices may perform a notifying step of secure authentication. The built-in operating system may use a dialog to show a message about the operating programs or applications to be downloaded, such that the users can base the message to make sure if they have to download the operating programs or applications. In order to prevent improper applications or operating programs hacking into the electronic device, a developer's authority for the applications or operating programs is limited. However, the smart-phone, the tablet, or the others electronic devices may have different operating systems, for example, Android system or Apple (iOS) system, and the difference in the built-in memory size thereof may also affect their operating mode for the downloading, the file management system or the applications. Therefore, the allowable operation of the control authority for the operating system program of the smart-phone, the tablet, or the others electronic devices may be determined in different ways. In addition, the operating steps become more complex and result in many limitations and problems for the applications of the smart-phone, the tablet or the notebook. Thus, many drawbacks and inconveniences are still existed when performing above operating steps practically. And, these problems should be solved indeed.

Besides, when most people replace the original smart-phones, tablets or other electronic devices with new ones, they have to back up data and communication groups stored in the memory or SIM card of the original electronic devices, and then copy the stored data and the stored communication groups into new electronic devices or new SIM cards. Not only the duplicated copy process is complex, but the data may be lost or deleted mistakenly during the process of backing up data. In addition, uncompleted data may also be backed up to the new electronic device, such that most people spend a lot of time and energy in copying data when they want to replace the original smart-phone, tablet, or electronic device with the new ones. So, such problem must be improved.

Therefore, how to solve the problem that the portable electronic device has to wait for the confirmation of the control authority and the file management or applications cannot be performed quickly when the portable electronic device is operated to perform a task of transmitting the electronic data. And, for the electronic data inside the portable electronic device, the drawbacks and problems about the complex back-up process and the inconvenient operating process need to be improved for related companies engaged in this field.

### SUMMARY OF THE INVENTION

Based on the problems and the drawbacks described above, the inventor concentrates on the solution and develops the disclosure by years of practical experience in this field and wealth of professional knowledge. After trying and modifying the disclosure continuously, the inventor has designed such disclosure which can quickly acquire the control authority for the operating system of the default portable electronic device, to provide the execution of the download, the storing or the transmission for the file management or the applications, and to provide for a memory or a mobile power bank a disclosure of control method for a portable electronic device coming with an external control module.

The main objective of the present disclosure is to provide a control module of which a main body has a built-in circuit system and a power supplying unit. The circuit system has a processor and related circuit layouts, and the power supplying unit provides power to the circuit system and the processor required, and the processor is electronically connected to an electronic connector. When the electronic connector is electronically connected to the default portable electronic device outside (which may be a smart-phone, a tablet or a notebook), the processor of the main body can acquire an authority control for the operating system (which may be Apple (iOS) or Android system (Android)) of the default portable electronic device via the electronic connector, so as to achieve the purpose for providing electronic signals transmission and storing between the control module and the default portable electronic device, without additionally operating the operating system, device manager or others setting of the default portable electronic device. Therefore, the operating steps and procedures in which the default portable electronic device transmits the electronic signals can be reduced.

The secondary objective of the present disclosure is that the main body may be an USB Flash drive, an USB hard disk, a multimedia storage device or a mobile power bank, and the processor of the built-in circuit system of the main body may be a micro controller (MCU) or a single-chip microcomputer. Further, the circuit system is electronically connected with a memory unit. The processor has a built-in operating system and the operating system may be an embedding operating system (Embedded Linux OS). The embedding operating system has ADB (Android Debug Bridge) Host application. Besides, the power supplying unit inside the main body may be a battery, a rechargeable battery or a lithium battery and so forth, and it may provide power to the built-in circuit system of the main body and the processor required. It also makes the main body to be a mobile power bank or a charger which may charge the default portable electronic device.

Another objective of the present invention is related to the circuit system of the main body, which is electronically connected with the memory unit. After the processor of the main body acquires the control authority for the operating system of the default portable electronic device, the electronic data stored in the memory or SIM card of the default portable electronic device is allowed to be backed up to the memory unit of the main body. That is, it allows the default portable electronic device to perform the electronic data back-up process, and the back-up data may be duplicated into the internal memory unit and a SIM card of the default portable electronic device or a new default portable electronic device. Furthermore, the memory unit electronically connected with the circuit system may be a memory or an expandable memory card, an SD card or a micro SD card.

Another objective of the present disclosure is related to an electronic connector which is connected with the processor of the main body. The electronic connector may be various types of electronic connectors, such as a micro universal serial bus (Micro USB), a mini universal serial bus (Mini USB), a universal serial bus (USB 2.0 or USB 3.0), or various types of electronic connectors of an Apple connector or a Lightning connector, and the electronic connector is exposed out of the main body (which may be a socket electronic connector, a plug electronic connector, or signal transmission line) for electronically connecting with the default portable electronic device conveniently. Therefore, such default portable electronic device may be the smart-phone, the tablet, the notebook, and so on.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 shows a perspective appearance view according to the present invention.

FIG. 2 shows a simple circuit block diagram according to the present invention.

FIG. 3 shows a perspective appearance view according to a preferably embodiment of the present invention.

FIG. 4 shows a flow chart (A) according to an operation mode of the present invention.

FIG. 5 shows a flow chart (B) according to an operation mode of the present invention.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

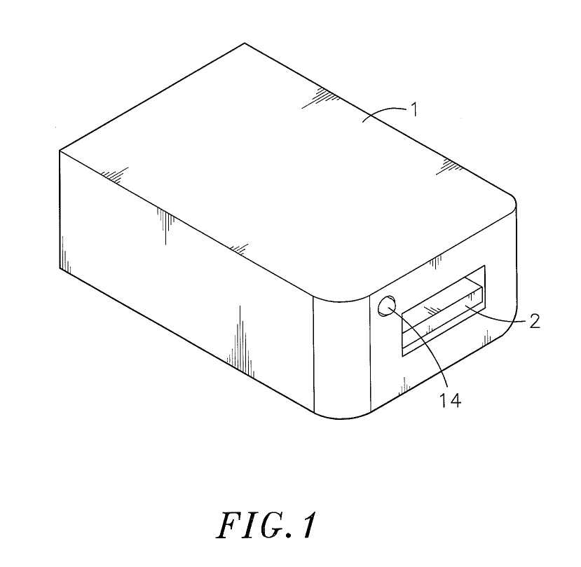

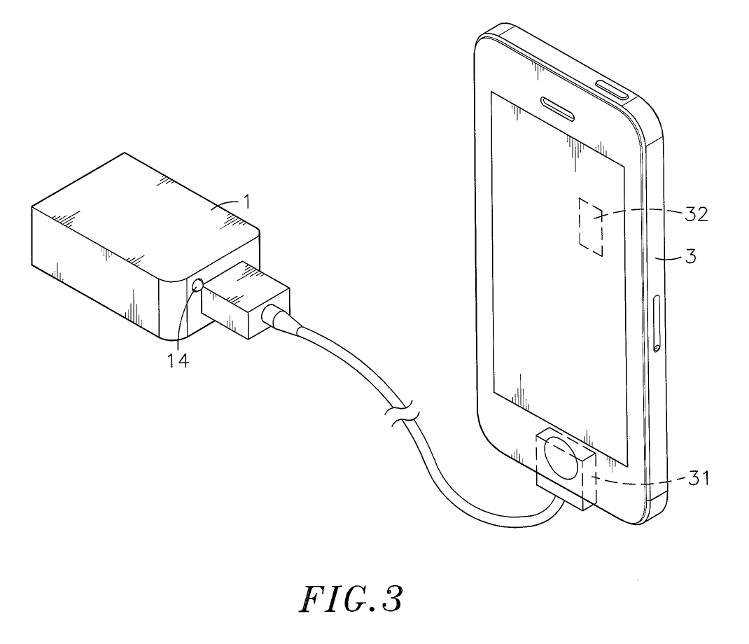

Please refer to FIGS. 1, 2 and 3, which are perspective appearance views and simple circuit block diagram according to a preferably embodiment respectively. As shown in Figs, it is clear that the external control module of the portable electronic device of the present disclosure may include a main body 1 and an electronic connector 2.

Preferably, the main body 1 may be an USB Flash drive, an USB hard disk, a multimedia storage device or a mobile power bank. The main body 1 has a built-in circuit system 11 and a processor 12, and the processor 12 is electronically connected with a power supplying unit 13, at least one indicator 14 and a memory unit 15 respectively.

The electronic connector 2 may be various types of electronic signal transmission interfaces of various electronic connectors 2, such as a micro universal serial bus (Micro USB), a mini universal serial bus (Mini USB), a universal serial bus (USB 2.0 or USB 3.0), or the socket electronic connector 2, the plug electronic connector 2 or the signal transmission line for an Apple connector or a Lightning connector.

When the components described as above are assembled, the main body 1 is assembled with the electronic connector 2, such that the electronic connector 2 is exposed out of the main body 1 (the electronic connector 2 may be a socket, plug, or signal transmission line, and so on). And, the electronic connector 2 may be electronically connected with the processor 12 of the circuit system 11 of the main body 1. That is, the control module of the portable electronic device of the disclosure is composed of the main body 1 and the electronic connector 2.

The processor 12 disposed on the built-in circuit system 11 of the main body 1 may be a micro controller (MCU) or a single-chip microcomputer and so on. The processor 12 is electronically connected with at least one indicator 14, and the indicator 14 may be a Light-emitting diode (LED), small bulbs, LCD panel, touch panel, or Electro Luminscence and so on, which reveals the operating status and applying mode for the circuit system 11 and the processor 12 of the main body 1. The processor 12 has a built-in embedded operating system (Embedded Linux OS), and the embedding operating system has ADB (Android Debug Bridge) Host application. As to the processor 12 of the main body 1, it may be electronically connected with at least one electronic connector 2. After the electronic connector 2 (which may be a socket, a plug, or a signal transmission line) is electronically connected with the default portable electronic device 3 (such as a socket, a plug, or a signal transmission line of the electronic connector interface 31 of a smart-phone, a tablet, a notebook), a transmission of electronic signals or power and the storage or the access of the electronic data can be performed rapidly.

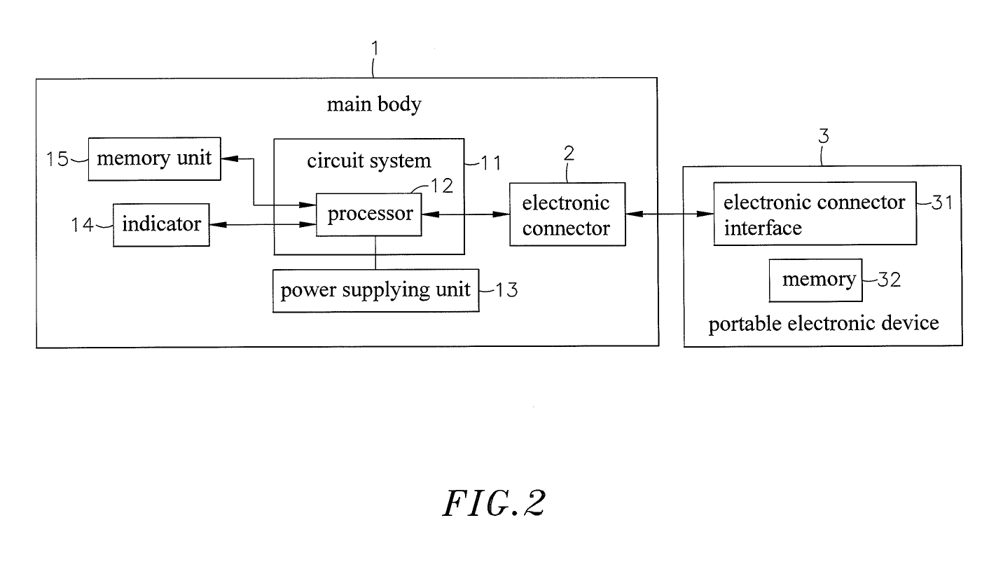

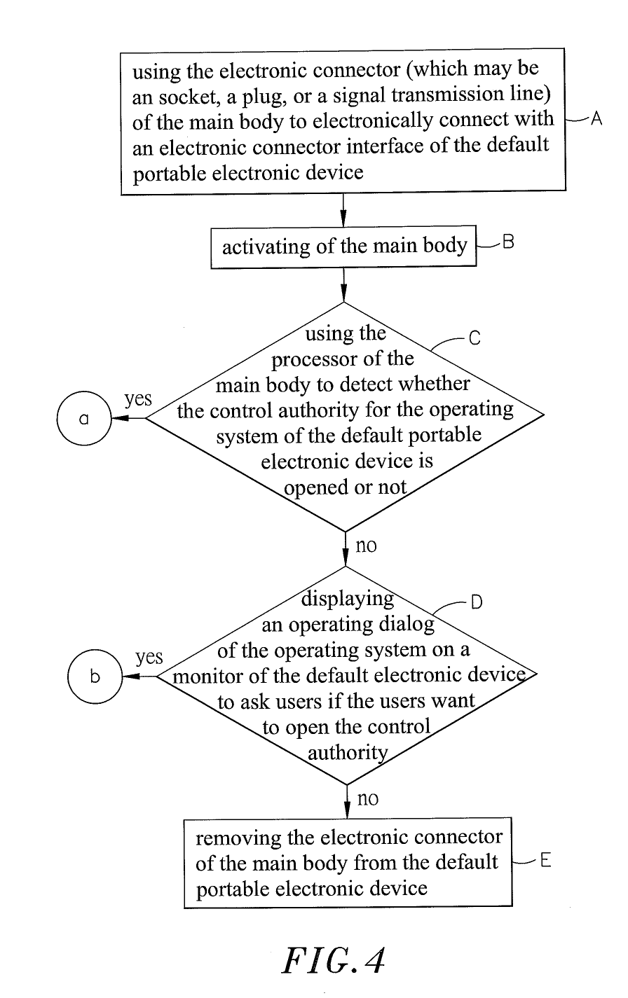

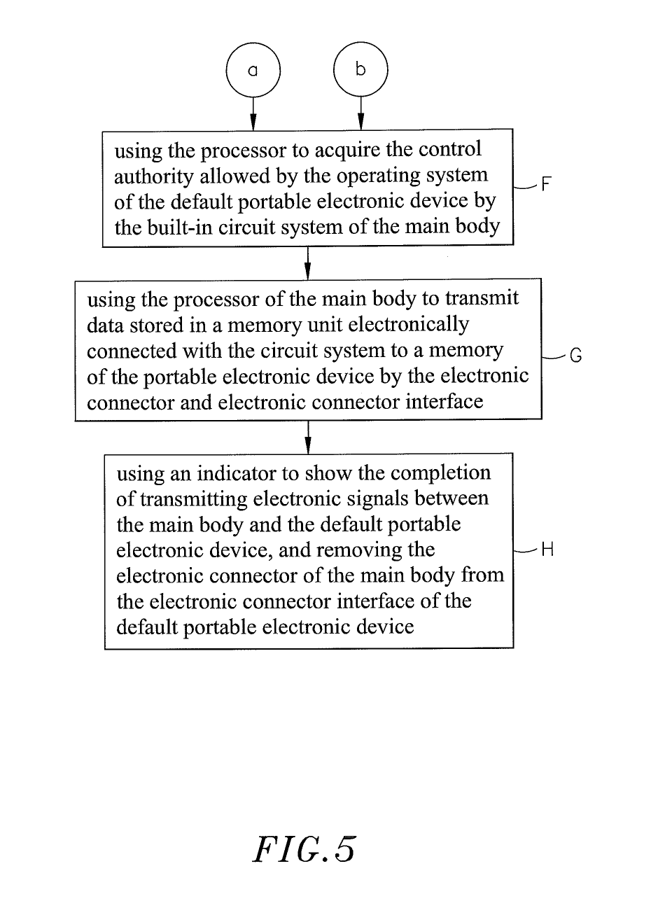

Please refer to FIGS. 2, 3, 4 and 5 which are a simple circuit block diagram, a perspective appearance view according to a preferably embodiment, a flow chart (A) according to an operation mode and a flow chart (B) according to an operation mode, respectively. As shown in Figs, it is clear that a controlling method for the external control module of the portable electronic device of the present disclosure for the practical application may include following steps:

(A) using the electronic connector 2 of the main body 1, such as an socket, a plug, or a signal transmission line, to electronically connect with an electronic connector interface 31 of the default portable electronic device 3;

(B) activating of the main body 1;

(C) using the processor 12 of the main body 1 to detect whether the control authority for the operating system (which may be Apple (iOS) system or Android system (Android)) of the default portable electronic device 3 is opened or not; if the control authority is opened, step (F) is performed; otherwise, step (D) is performed;

(D) displaying an operating dialog of the operating system on a monitor of the default electronic device 3 to ask users if the users want to open the control authority; if yes, step (F) is performed; otherwise, step (E) is performed;

(E) removing the electronic connector 2 of the main body 1 from the default portable electronic device 3;

(F) using the processor 12 to acquire the control authority allowed by the operating system of the default portable electronic device 3 by the built-in circuit system 11 of the main body 1;

(G) using the processor 12 of the main body 1 to transmit data stored in a memory unit 15 electronically connected with the circuit system 11 to a memory 32 of the portable electronic device 3 by the electronic connector 2 and electronic connector interface 31;

(H) using an indicator 14 to show the completion of transmitting electronic signals between the main body 1 and the default portable electronic device 3, and removing the electronic connector 2 of the main body 1 from the electronic connector interface 31 of the default portable electronic device 3.

As described above, by the electronic connector 2 of the main body 1 electronically connected with an electronic connector interface 31 of the portable electronic device 3, the processor 12 of the built-in circuit system 11 of the main body 1 may acquire the control authority for the operating system of the default portable electronic device, and the default portable electronic device 3 does not need to request the authority granted by the operating system for each operation. Since the built-in operating system of the default portable electronic device 3 would perform a notifying step of secure authentication and uses a dialog to show an electronic message about the file management or applications to be performed, so the users can base the message to make sure and decide if they have to download the operating programs or applications. The main body 1 acquires the control authority for the operating system of the portable electronic device 3, namely, the main body 1 has the control authority for file management and electronic signal transmission, and it doesn't affect the normal usage of other operating systems and applications of the default portable electronic device 3. And, when using the main body 1 to control the default portable electronic device 3 performing the task related to the electronic signal transmission, the file management or the application, the operating status of the main body 1 can be revealed by connecting the circuit system 11 of the main body 1 with at least one indicator 14, such that users may understand the electronic signal transmission status between the main body 1 and the default portable electronic device 3 can be acquired by different colors of lights of at least one indicator 14 showing. And the purpose of using the main body 1 to conveniently perform the task of file management and application for the default portable electronic device 3 is achieved. Furthermore, the processor 12 of the main body 1 may also controls a download authority when a system of the default portable electronic device 3 connects to the Internet. After downloaded data, operating system or applications are transmitted to the processor 12 by the electronic connector interface 31 and electronic connector 2, the processor 12 will store (or read) the downloaded data, the operating system or the applications into the memory unit 15.

Furthermore, after the main body 1 is electronically connected with the electronic connector interface 31 of the default portable electronic device 3 by the electronic connector 2, the power supplying unit 13 inside the main body 1 may be used to charge the default portable electronic device 3. The main body 1 may be an applying mode of a charger or a mobile power bank, and the power supplying unit 13 may be a battery, a rechargeable battery or a lithium battery and so forth. If the built-in memory unit 15 of the main body 1 is used for data storing and transmission, it will become a storage device (an USB Flash drive, an USB hard disk, and so on) or a multimedia storage device. And based on different applying mode of the main body 1, it may generate different functionalities and act as mobile power bank, storage device, USB Flash drive or multimedia storage device. And, the circuit system 11 of the main body 1 is connected with the memory unit 15 which may be a memory or an expandable memory card, an SD card or a micro SD card, and so on. After the processor 12 of the main body 1 acquires the control authority for the operating system inside the default portable electronic device 3, the electronic data stored in the memory or a SIM card of the default portable electronic device 3 will be backed up to the memory unit 15 of the main body 1, to become a back-up data of the default portable electronic device. Then, the back-up electronic data of the memory unit 15 of the main body 1 may be duplicated into the memory and the SIM card of the default portable electronic device 3 or a new default portable electronic device 3, to achieve the purpose of quickly backing up internal electronic data and applications of the default portable electronic device 3 by using the memory unit 15 of the main body 1.

The control method for a portable electronic device coming with an external control module. The main body 1 may built in a circuit system 11 and a processor 12, and the processor 12 is electronically connected with a power supplying unit 13, at least one indicator 14 and a memory unit 15 respectively. The processor 12 is electronically connected with electronic connector 2 (which may be a socket, a plug, or a signal transmission line, and so on) which is exposed out of the main body 1 for electronically connecting with the electronic connector interface 31 of the default portable electronic device. Namely, the processor 12 may acquire the control authority for the operating system of the default portable electronic device by the electronic connector 2 and the electronic connector interface 31, to achieve the purpose of using the processor 12 to control the electronic signal transmission between the processor 12 and the default portable electronic device 3, and to use the processor 12 of the main body 1 to control the functionality of downloading operating system or applications performed by the default portable electronic device 2 when the default portable electronic device 2 connects to the Internet. Besides, by charging the default portable electronic device 3, the power supplying unit 13 inside the main body 1 may become a mobile power bank, and the memory unit 15 of the main body 1 also provides the default portable electronic device 3 performing the data back-up.

Therefore, the present disclosure is designed for providing a control method for a portable electronic device coming with an external control module. The control method uses a electronic connector arranged in the main body electronically connect with an electronic connector interface of the default portable electronic device, and the processor of the main body acquires the control authority for the operating system of the default electronic device, so as to achieve the major claimed invention of using the main body to control the electronic signal of the default portable electronic device, to use the main body control the control authority for the operating system of the portable electronic device, and to control the download data process and application when the default portable electronic device connects to the Internet. Furthermore, the power supplying unit not only provides the necessary power for operating the circuit system of the main body, but charges the default portable electronic device by the electronic connector and the electronic connector interface, to have the convenience of being mobile power bank of the default portable electronic device. In addition, the memory unit of the main body may also provide the default portable electronic device performing the data back-up.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A control method for a portable electronic device coming with an external control module, said external control module comprising a main body and an electronic connector, said main body comprising a built-in circuit system with a processor and a power supplying unit for providing power to said circuit system and said processor required, said processor of said main body electronically connected to said electronic connector and said electronic connector exposed out of said main body to connect electronically with said default portable electronic device to enable said processor to acquire a control authority for said operation system of said portable electronic device, said control method comprising steps:
(A) electronically connecting said electronic connector of said main body with an electronic connector interface of said default portable electronic device;
(B) activating said main body;
(C) using said processor of said main body to detect whether said control authority for said operating system of said default portable electronic device is opened or not; if yes, performing step (F); otherwise, performing step (D);
(D) displaying an operating dialog of said operating system on a monitor of said default electronic device to ask users if said users want to open said control authority; if yes, performing step (F); otherwise, performing step (E);
(E) removing said electronic connector of said main body from said default portable electronic device;
(F) using said processor to acquire said control authority allowed by said operating system of said default portable electronic device by said built-in circuit system of said main body;
(G) using said processor of said main body to transmit data stored in a memory unit which is electronically connected with said circuit system to a memory of said portable electronic device;
(H) completing said electronic signal transmission task between said main body and said default portable electronic device, and removing said electronic connector of said main body from said electronic connector interface of said default portable electronic device.

2. The control method of claim 1, wherein said processor of said main body is built with an embedded operating system (Embedded Linux OS), and said embedding operating system has ADB (Android Debug Bridge) Host application or operating program.

3. The control method of claim 1, wherein said main body is equipped with said built-in circuit system, said circuit system is electronically connected with said electronic connector exposed out of said main body, and said electronic connector is a socket electronic connector, a plug electronic connector, or a signal transmission line.

4. The control method of claim 3, wherein said electronic connector is a micro universal serial bus (Micro USB), a mini universal serial bus (Mini USB), a universal serial bus (USB 2.0 or USB 3.0), or said socket electronic connector, said plug electronic connector, or said signal transmission line of an Apple connector type or a Lightning connector type.

5. The control method of claim 1, wherein said main body has a built-in circuit system which is electronically connected with said memory unit, said memory unit is a memory or a memory card, and said memory card comprises an SD card or a micro SD card (Micro SD card).

6. The control method of claim 1, wherein said processor of said main body also controls a download authority when a system of said default portable electronic device is connected to said Internet, and downloaded data or applications are transmitted to said processor by said electronic connector interface and said electronic connector, and then they are stored in said memory unit.

7. The control method of claim 1, wherein said power supplying unit inside said main body is a battery, a rechargeable battery or a lithium battery.

8. The control method of claim 1, wherein said operating system of said portable electronic device is Apple operating system (iOS) or Android operating system (Android).
